(19) United States
(12) Patent Application Publication
(10) Pub. No.: US 2015/0033850 A1
(43) Pub. Date: Feb. 5, 2015

(54) DETECTION MODULE FOR SENSOR AND ANGULAR VELOCITY SENSOR HAVING THE SAME

(71) Applicant: SAMSUNG ELECTRO-MECHANICS CO., LTD., Suwon (KR)

(72) Inventors: Won Kyu Jeung, Suwon (KR); Jong Woon Kim, Suwon (KR); Jung Won Lee, Suwon (KR)

(73) Assignee: SAMSUNG ELECTRO-MECHANICS CO., LTD., Suwon (KR)

(21) Appl. No.: 14/066,293

(22) Filed: Oct. 29, 2013

(30) Foreign Application Priority Data
Aug. 2, 2013 (KR) 10-2013-0091936

(51) Int. Cl. G01C 19/56

(52) U.S. Cl. CPC G01C 19/56
USPC 73/504.12

(57) ABSTRACT

Disclosed herein is a detection module for a sensor, including: a mass body part including a first mass body including a first one side mass body and a first other side mass body connected to each other by a coupling elastic member, and a second mass body; a frame supporting the first mass body and the second mass body; first flexible parts each connecting the first mass body and the second mass body to the frame; and second flexible parts each connecting the first mass body and the second mass body to the frame, wherein the second flexible parts are connected to the first mass body so as to correspond to the center of gravity of the first mass body and the second mass body is connected to the frame so as to be eccentric by the second flexible parts.

### CROSS REFERENCE TO RELATED APPLICATION

This application claims the benefit of Korean Patent Application No. 10-2013-0091936, filed on Aug. 2, 2013, entitled “Detection Module for Sensor and Angular Velocity Sensor having the Same”, which is hereby incorporated by reference in its entirety into this application.

### BACKGROUND OF THE INVENTION

1. Technical Field

The present invention relates to a detection module for a sensor and an angular velocity sensor having the same.

2. Description of the Related Art

Recently, an angular velocity sensor has been used in various applications, for example, military such as an artificial satellite, a missile, an unmanned aircraft, or the like, vehicles such as an air bag, electronic stability control (ESC), a black box for a vehicle, or the like, hand shaking prevention of a camcorder, motion sensing of a mobile phone or a game machine, navigation, or the like.

The angular velocity sensor generally adopts a configuration in which a mass body is adhered to an elastic substrate such as a membrane, or the like, in order to measure angular velocity. Through the configuration, the angular velocity sensor may calculate the angular velocity by measuring Coriolis force applied to the mass body.

In detail, a scheme of measuring the angular velocity using the angular velocity sensor is as follows. First, the angular velocity may be measured by Coriolis force “F=2mΩv”, where “F” represents the Coriolis force applied to the mass body, “m” represents the mass of the mass body, “Ω” represents the angular velocity to be measured, and “v” represents the motion velocity of the mass body. Among others, since the motion velocity v of the mass body and the mass m of the mass body are values known in advance, the angular velocity Ω may be obtained by detecting the Coriolis force (F) applied to the mass body.

Meanwhile, the angular velocity sensor according to the prior art includes a piezoelectric material disposed on a membrane (a diaphragm) in order to sense driving of a mass body or displacement of the mass body, as disclosed in Patent Document of the following Prior Art Document. In order to measure the angular velocity using the angular velocity sensor, it is preferable to allow a resonant frequency of a driving mode and a resonant frequency of a sensing mode to almost coincide with each other. However, very large interference occurs between the driving mode and the sensing mode due to a fine manufacturing error caused by a shape, stress, a physical property, or the like. Therefore, since a noise signal significantly larger than an angular velocity signal is output, circuit amplification of the angular velocity signal is limited, such that sensitivity of the angular velocity sensor is deteriorated.

### PRIOR ART DOCUMENT

### Patent Document

(Patent Document 1) US20110146404 A1

### SUMMARY OF THE INVENTION

The present invention has been made in an effort to provide a detection module for a sensor capable of integrating a sensing mode by mechanically coupling a plurality of mass bodies and having characteristics such as high sensitivity, low off-axis sensitivity, low noise, and low drift, and an angular velocity sensor having the same.

Further, the present invention has been made in an effort to provide a detection module for a sensor capable of simultaneously detecting physical amounts for multiple axes by generating different displacements by a mass body including a first mass body connected to correspond to the center of gravity and a second mass body connected to be spaced apart from the center of gravity, and an angular velocity sensor having the same.

Further, the present invention has been made in an effort to provide a driving part integral type angular velocity sensor capable removing interference between a driving mode and a sensing mode and decreasing an effect caused by a manufacturing error by including a plurality of frames, driving the frames and the mass body by one driving part to individually generate driving displacement and sensing displacement of the mass body and forming a flexible part so that the mass body is movable only in a specific direction.

Further, the present invention has been made in an effort to provide an angular velocity sensor capable of detecting an angular velocity of three axes by the mass body included in the frame including a first mass body connected to correspond to the center of gravity and a second mass body connected to be spaced apart from the center of gravity and different driving and displacements of the first mass body and the second mass body caused by the frame driving.

According to a preferred embodiment of the present invention, there is provided a detection module for a sensor, including: a mass body part including a first mass body including a first one side mass body and a first other side mass body connected to each other by a coupling elastic member, and a second mass body; a frame supporting the first mass body and the second mass body; first flexible parts each connecting the first mass body and the second mass body to the frame; and second flexible parts each connecting the first mass body and the second mass body to the frame, wherein the second flexible parts are connected to the first mass body so as to correspond to the center of gravity of the first mass body and the second mass body is connected to the frame so as to be eccentric by the second flexible part.

One end portion of the first one side mass body and the first other side mass body may be each connected to the frame by the second flexible parts and the other end portions thereof facing each other are connected to each other by the coupling elastic member.

The first flexible part and the second flexible part may be disposed in a direction perpendicular to each other.

The first flexible part may be a beam having a surface formed by one axis direction and the other axis direction, and having a thickness extended to a direction perpendicular to the surface.

The second flexible part may be a hinge having a thickness in one axis direction and having a surface formed in the other axis direction.

One surface of the first flexible parts or the second flexible parts is selectively provided with a sensing unit sensing a displacement of the first mass body and the second mass body.

According to another preferred embodiment of the present invention, there is provided an angular velocity sensor, including: a mass body part including a first mass body including a first one side mass body and a first other side mass body connected to each other by a coupling elastic member, and a second mass body; an internal frame supporting the first mass body and the second mass body; first flexible parts each connecting the first mass body and the second mass body to the internal frame; second flexible parts each connecting the first mass body and the second mass body to the internal frame; an external frame supporting the internal frame; a third flexible part connecting the internal frame and the external frame to each other; and a fourth flexible part connecting the internal frame and the external frame to each other, wherein the second flexible parts are connected to the first mass body so as to correspond to the center of gravity of the first mass body and the second mass body is connected to the internal frame so as to be eccentric by the second flexible part.

One end portion of the first one side mass body and the first other side mass body may be each connected to the internal frame by the second flexible parts and the other end portions thereof facing each other are connected to each other by the coupling elastic member.

The first flexible part and the second flexible part may be disposed in a direction perpendicular to each other.

The third flexible part and the fourth flexible part may be disposed in a direction perpendicular to each other.

The third flexible part may be disposed in a direct perpendicular to the first flexible part.

The fourth flexible part may be disposed in a direct perpendicular to the second flexible part.

The first flexible part may be a beam having a surface formed by one axis direction and the other axis direction, and a thickness extended to a direction perpendicular to the surface.

The first flexible part may be a beam having a predetermined thickness in a Z axis direction and configured by a surface formed by an X axis and a Y axis and may be formed to have a width W₁ in an X axis direction larger than a thickness T₁ in the Z axis direction.

The first flexible parts may be connected between one end of the second mass body and the internal frame in a Y axis direction.

One surface of the first flexible parts or the second flexible parts may be selectively provided with a sensing unit sensing a displacement of the first mass body and the second mass body.

The second flexible part may be a hinge having a thickness in one axis direction and a surface formed in the other axis direction.

The second flexible part may be a hinge having a predetermined thickness in a Y axis direction and a surface formed by an X axis and a Z axis and may be formed to have a width W₂ in a Z axis direction larger than a thickness T₂ in the Y axis direction.

The second flexible part may have a hinge shape having a rectangular cross section or a torsion bar shape having a circular cross section.

The third flexible part may be a beam having a surface formed by one axis direction and the other axis direction, and a thickness extended to a direction perpendicular to the surface.

The third flexible part may be a beam having a predetermined thickness in a Z axis direction and configured by a surface formed by an X axis and a Y axis and may be formed to have a width W₃ in a Y axis direction larger than a thickness T₃ in the Z axis direction.

The fourth flexible part may be a hinge having a thickness in one axis direction and a surface formed in the other axis direction.

The fourth flexible part may be a hinge having a predetermined thickness in an X axis direction and configured by a surface formed by a Y axis and a Z axis and may be formed to have a width W₄ in a Z axis direction larger than a thickness T₄ in the X axis direction.

One surface of the third flexible parts or the fourth flexible parts may be selectively provided with a driving unit driving the internal frame.

When the internal frame is driven by the driving unit of the third flexible part, the internal frame may be rotated based on an axis to which the fourth flexible part is coupled, with respect to the external frame.

When the internal frame is rotated based on the axis to which the fourth flexible part is coupled, the third flexible part may generate bending stress and the fourth flexible part generates twisting stress.

When the internal frame is rotated based on the axis to which the fourth flexible part is coupled, the first mass body and the second mass body may be rotated based on an axis to which the second flexible parts are coupled, with respect to the internal frame.

When the first mass body and the second mass body are rotated, the first flexible parts may generate the bending stress and the second flexible parts generate the twisting stress.

The second mass body may have one end portion to which the first flexible parts are connected, in a Y axis direction and the other end portion to which the second flexible parts are connected, in an X axis direction.

According to still another preferred embodiment of the present invention, there is provided an angular velocity sensor, including: a mass body part including a first mass body configured of a first one side mass body and a first other side mass body connected to each other by a coupling elastic member, and a second mass body configured of a second one side mass body and a second other side mass body disposed to face each other based on the coupling elastic member; an internal frame supporting the first mass body and the second mass body; first flexible parts each connecting the first mass body and the second mass body to the internal frame; second flexible parts each connecting the first mass body and the second mass body to the internal frame; an external frame supporting the internal frame; a third flexible part connecting the internal frame and the external frame to each other; and a fourth flexible part connecting the internal frame and the external frame to each other, wherein the second flexible parts are connected to the first mass body so as to correspond to the center of gravity of the first mass body and the second mass body is connected to the internal frame so as to be eccentric by the second flexible parts.

One end portion of the first one side mass body and the first other side mass body may be each connected to the internal frame by the second flexible parts and the other end portions thereof facing each other are connected to each other by the coupling elastic member.

The internal frame may be provided with a first space part in which the first one side mass body and the first other side mass body are embedded, a second space part in which the second one side mass body is embedded, and a third space part in which the second other side mass body is embedded.

The first flexible part may be a beam having a surface formed by one axis direction and the other axis direction and having a thickness extended to a direction perpendicular to the surface, and the second flexible part may be a hinge having a thickness in one axis direction and having a surface formed in the other axis direction.

One surface of the first flexible parts or the second flexible parts may be selectively provided with a sensing unit sensing a displacement of the first mass body and the second mass body.

The third flexible part may be a beam having a surface formed by one axis direction and the other axis direction and having a thickness extended to a direction perpendicular to the surface, and the fourth flexible part may be a hinge having a thickness in one axis direction and having a surface formed in the other axis direction.

One surface of the third flexible part or the fourth flexible part may be selectively provided with a driving unit driving the internal frame.

According to yet still another preferred embodiment of the present invention, there is provided an angular velocity sensor, including: a mass body part including a first mass body configured of a first one side mass body and a first other side mass body connected to each other by a coupling elastic member, and a second mass body configured of a second one side mass body and a second other side mass body disposed to face each other based on the first mass body; an internal frame supporting the first mass body and the second mass body; first flexible parts each connecting the first mass body and the second mass body to the internal frame; second flexible parts each connecting the first mass body and the second mass body to the internal frame; an external frame supporting the internal frame; a third flexible part connecting the internal frame and the external frame to each other; and a fourth flexible part connecting the internal frame and the external frame to each other, wherein the second flexible parts are connected to the first mass body so as to correspond to the center of gravity of the first mass body and the second mass body is connected to the internal frame so as to be eccentric by the second flexible parts.

One end portion of the first one side mass body and the first other side mass body may be each connected to the internal frame by the second flexible parts and the other end portions thereof facing each other are connected to each other by the coupling elastic member.

The internal frame may be provided with a first space part in which the first one side mass body and the first other side mass body are embedded, a second space part in which the second one side mass body is embedded, and a third space part in which the second other side mass body is embedded.

The first flexible part may be a beam having a surface formed by one axis direction and the other axis direction and having a thickness extended to a direction perpendicular to the surface, and the second flexible part may be a hinge having a thickness in one axis direction and having a surface formed in the other axis direction.

One surface of the first flexible parts or the second flexible parts may be selectively provided with a sensing unit sensing a displacement of the first mass body and the second mass body.

The third flexible part may be a beam having a surface formed by one axis direction and the other axis direction and having a thickness extended to a direction perpendicular to the surface, and the fourth flexible part may be a hinge having a thickness in one axis direction and having a surface formed in the other axis direction.

One surface of the third flexible part or the fourth flexible part may be selectively provided with a driving unit driving the internal frame.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view schematically showing a detection module for a sensor according to a preferred embodiment of the present invention;

FIG. 2 is a plan view of the detection module for the sensor shown in FIG. 1;

FIG. 3 is a perspective view schematically showing an angular velocity sensor according to a first preferred embodiment of the present invention;

FIG. 4 is a plan view of the angular velocity sensor shown in FIG. 3;

FIG. 5 is a schematic cross-sectional view taken along a line A-A of the angular velocity sensor shown in FIG. 3;

FIG. 6 is a schematic cross-sectional view taken along a line B-B of the angular velocity sensor shown in FIG. 3;

FIG. 7 is a schematic cross-sectional view taken along a line C-C of the angular velocity sensor shown in FIG. 3;

FIG. 8 is a plan view showing movable directions of a first mass body, a second mass body, and an internal frame in the angular velocity sensor shown in FIG. 4;

FIGS. 9A and 9B are cross-sectional views showing a process in which the first mass body and the second mass body shown in FIG. 7 are rotated based on a second flexible part with respect to the internal frame;

FIGS. 10A and 10B are cross-sectional views showing a process in which the internal frame shown in FIG. 6 is rotated based on a fourth flexible part with respect to an external frame;

FIG. 11 is a perspective view schematically showing an angular velocity sensor according to a second preferred embodiment of the present invention.

FIG. 12 is a plan view of the angular velocity sensor shown in FIG. 11;

FIG. 13 is a schematic cross-sectional view taken along a line A-A of the angular velocity sensor shown in FIG. 12;

FIG. 14 is a schematic cross-sectional view taken along a line B-B of the angular velocity sensor shown in FIG. 12;

FIG. 15 is a schematic cross-sectional view taken along a line C-C of the angular velocity sensor shown in FIG. 12;

FIG. 16 is a schematic cross-sectional view taken along a line D-D of the angular velocity sensor shown in FIG. 12;

FIG. 17 is a perspective view schematically showing an angular velocity sensor according to a third preferred embodiment of the present invention.

FIG. 18 is a plan view of the angular velocity sensor shown in FIG. 17;

FIG. 19 is a schematic cross-sectional view taken along a line A-A of the angular velocity sensor shown in FIG. 18; and

FIG. 20 is a schematic cross-sectional view taken along a line B-B of the angular velocity sensor shown in FIG. 18.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the accompanying drawings.

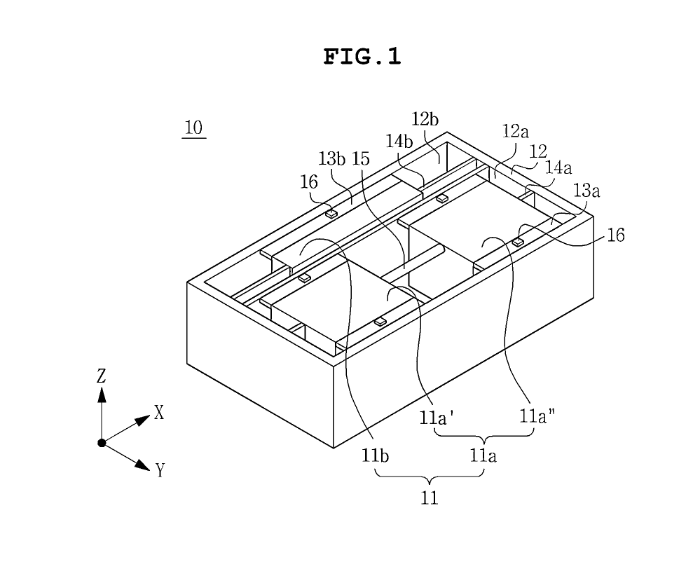

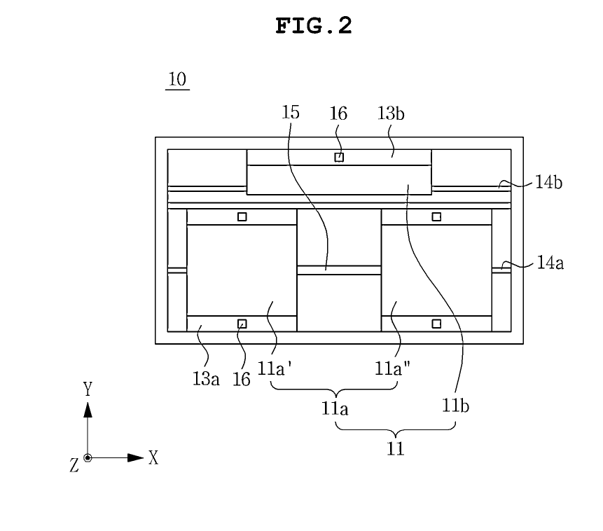

FIG. 1 is a perspective view schematically showing a detection module for a sensor according to a preferred embodiment of the present invention and FIG. 2 is a plan view of the detection module for the sensor shown in FIG. 1.

As shown, the detection module 10 for the sensor is configured to include a mass body part 11, a frame 12, a first flexible part 13, a second flexible part 14, and a coupling elastic member 15.

In addition, the first flexible part 13 and the second flexible part 14 are selectively provided with sensing units 16a and 16b, where the sensing units 16a and 16b may be formed in a piezoelectric scheme, a piezoresistive scheme, a capacitive scheme, an optical scheme, or the like, but are not particularly limited thereto.

More specifically, the mass body part 11, which generates displacement by Coriolis force, includes a first mass body 11a and a second mass body 11b.

In addition, a second flexible part 14 is connected to the center portion of the first mass body 11a so as to correspond to the center of gravity of the first mass body 11a and the second flexible part 14 is connected to the second mass body 11b so as to be spaced apart from the center of gravity. Therefore, the second mass body 11b is connected to the frame 12 so as to be eccentric by the second flexible part 14.

In addition, the first mass body 11a is configured of a first one side mass body 11a′ and a first other side mass body 11a″, where the first one side mass body 11a′ and the first other side mass body 11a″ may have the same size. In addition, the first one side mass body 11a′ and the first other side mass body 11a″ are connected to each other by the coupling elastic member 15.

This is to mechanically couple the first one side mass body 11a′ and the first other side mass body 11a″ to each other to integrate sensing modes, thereby providing characteristics such as high sensitivity, low off-axis sensitivity, low noise, and low drift.

That is, as described above, as the first one side mass body 11a′ and the first other side mass body 11a″ are connected to each other by the coupling elastic member 15, the resonance modes may be equally controlled by integrating resonance modes of the first one side mass body 11a′ and the first other side mass body 11a″, and sensor performance may be improved by an increase in sensitivity and a decrease in an off-axis sensitivity by adjusting a resonance frequency of the frame 12 connected to the first one side mass body 11a′ and the first other side mass body 11a″ and displacements in the resonance frequency of the first one side mass body 11a′ and the first other side mass body 11a″.

In addition, the first one side mass body 11a′ and the first other side mass body 11a″ which are the first mass body 11a are connected to the frame 12 by the first flexible part 13a and the second flexible part 14a.

Meanwhile, although the case in which the first mass body 11a has a substantially square pillar shape is shown, the first mass body 11a is not limited to having the above-mentioned shape, but may have all shapes known in the art.

In addition, the second mass body 11b is connected to the first flexible part 13b at only one end thereof in a Y axis direction. In addition, the second mass body 11b is connected to the second flexible part 14b at the other end portion thereof in an X axis direction. That is, one side with respect to the Y axis direction is connected to the frame 12 by the first flexible part 13a and the other side is connected to the frame 12 by the second flexible part 14b.

Next, the frame 12 is partitioned into two space parts 12a and 12b so that the first mass body 11a and the second mass body 11b may be embedded.

In addition, the first one side mass body 11a′ and the first other side mass body 11a″ which are the first mass body 11a are embedded in the first space part 12a of the frame 12 and the second mass body 11b is embedded in the second space part 12b.

In addition, the frame 12 secures a space in which the first mass body 11a and the second mass body 11b connected by the first flexible parts 13a and 13b and the second flexible parts 14a and 14b may be displaced and becomes a basis when the first mass body 11a and the second mass body 11b are displaced.

In addition, the frame 12 may have a square pillar shape in which it has a square pillar shaped cavity formed at the center thereof, but is not limited thereto.

In addition, the first one side mass body 11a′ and the first other side mass body 11a″ have one end portion each connected to the frame 12 by the second flexible part 14 in the X axis direction, and the other end portions facing each other are connected by the coupling elastic member 15.

In addition, both end portions of the second mass body 11b are connected to the frame 12 by the second flexible part 14 in the X axis direction. In this case, the second flexible part 14a is connected to the center portion of the first one side mass body 11a′ and the first other side mass body 11a″ in the Y axis direction and the second flexible part 14b is connected to the second mass body 11b so as to be spaced apart from the center portion by a predetermined interval in the Y axis direction.

That is, the second mass body 11b is connected to the frame so as to be eccentric by the second flexible part 14b.

In addition, each of the first mass body 11a and the second mass body 11b is each connected to the internal frame 12 by the first flexible parts 13a and 13b in the Y axis direction. In this case, the first mass bodies 11a′ and 11a″ has the first flexible part 13a connected to both end portions thereof and the second mass body 11b has the first flexible part 13b connected to only one end portion thereof.

In addition, the first flexible parts 13a and 13b are beams having a predetermined thickness in a Z axis direction and made of a surface formed by the X axis and Y axis. That is, the first flexible parts 13a and 13b are formed so as to have a width in the X axis direction larger than a thickness in the Z axis direction.

In addition, the first flexible part may be provided with a sensing unit 15. That is, when viewing based on an X-Y plane, since the first flexible part 13 is relatively wide as compared to the second flexible part 14, the first flexible parts 13a and 13b may be provided with sensing units 15a and 15b sensing the displacement of the first mass body 11a and the second mass body 11b.

In addition, the second flexible parts 14a and 14b are hinges having a predetermined thickness in the Y axis direction and having a surface formed by the X axis and the Z axis. That is, the second flexible parts 14a and 14b are formed so as to have a width in the Z axis direction larger than a thickness in the Y axis direction.

In addition, the first flexible parts 13a and 13b and the second flexible parts 14a and 14b are disposed in a direction perpendicular to each other. That is, the first flexible parts 13a and 13b are coupled to the mass body part 11 and the frame 12 in the Y axis direction, and the second flexible parts 14a and 14b are coupled to the mass body part 11 and the frame 12 in the X axis direction.

Through the above-mentioned configuration, since the second flexible parts 14a and 14b have the width in the Z axis direction larger than the thickness in the Y axis direction, the mass bodies 11a and 11b are limited from being rotated based on the Y axis or translated in the Z axis direction, but may be relatively freely rotated based on the X axis. That is, the mass bodies 11a and 11b are embedded in the internal frame 12 and are rotated based on the X axis direction and the second flexible parts 14a and 14b serve as a hinge for the above-mentioned rotation.

Through the above-mentioned configuration, when the frame is displaced, the first and second mass bodies 11a and 11b are applied with Coriolis force and displaced based on the internal frame 12 by bending of the first flexible parts 13a and 13b and twisting of the second flexible parts 14a and 14b. In addition, an angular velocity or acceleration may be detected by the displacement or a velocity of the mass body.

In addition, a method calculating the angular velocity by the detection module for the sensor according to the preferred embodiment of the present invention will be described in more detail through an angular velocity sensor described below.

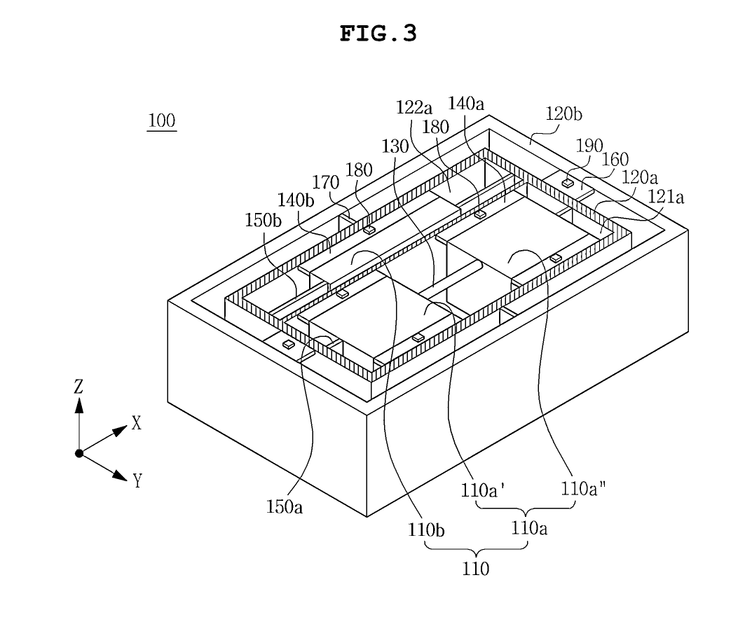

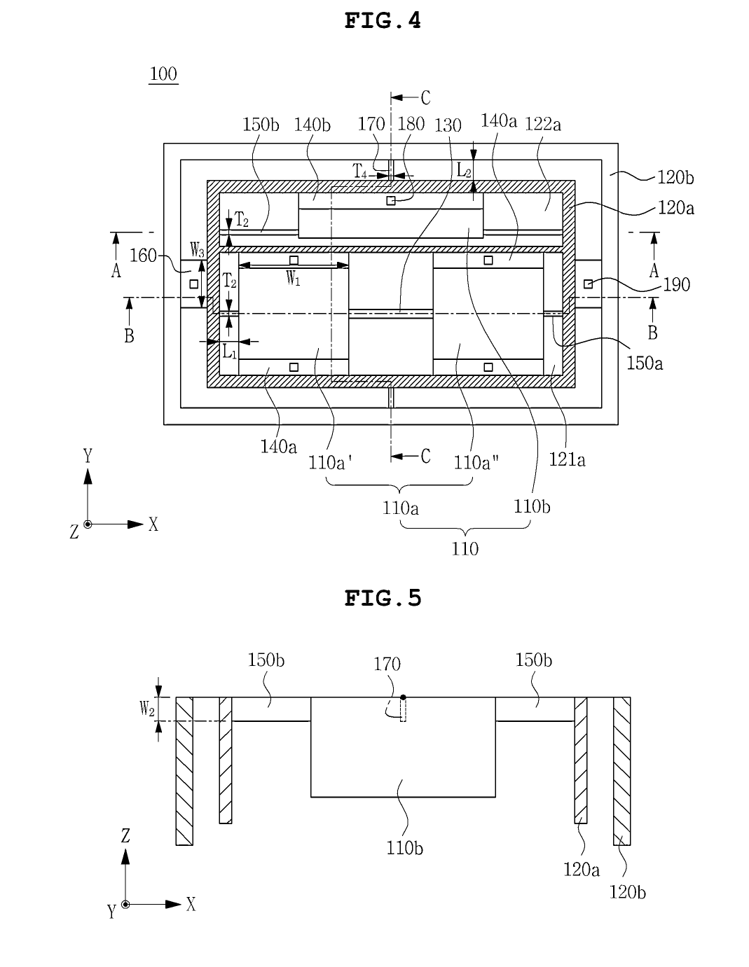

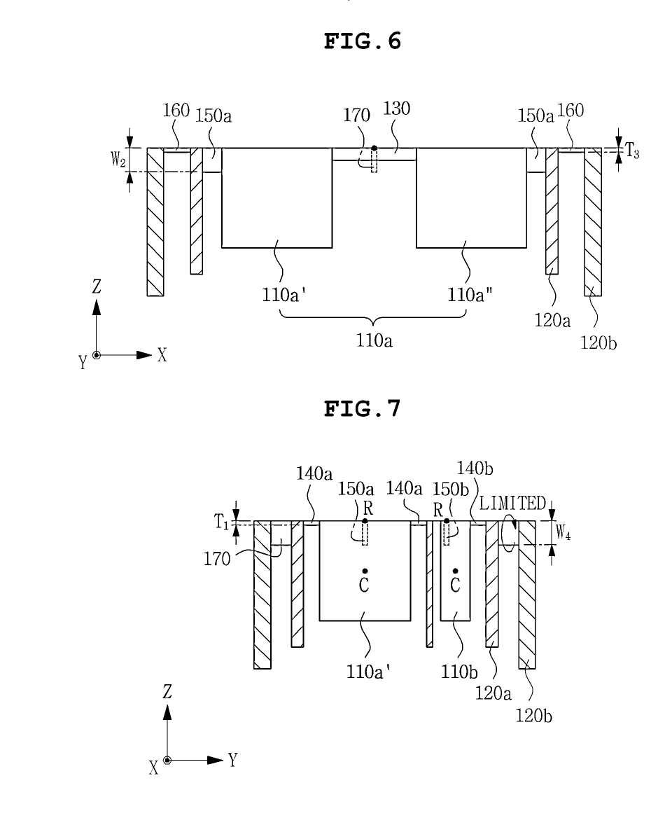

FIG. 3 is a perspective view schematically showing an angular velocity sensor according to a first preferred embodiment of the present invention, FIG. 4 is a plan view of the angular velocity sensor shown in FIG. 3, FIG. 5 is a schematic cross-sectional view taken along a line A-A of the angular velocity sensor shown in FIG. 3, FIG. 6 is a schematic cross-sectional view taken along a line B-B of the angular velocity sensor shown in FIG. 3, and FIG. 7 is a schematic cross-sectional view taken along a line C-C of the angular velocity sensor shown in FIG. 3.

As shown, the angular velocity sensor 100 is configured to include a mass body part 110, an internal frame 120a, an external frame 120b, a coupling elastic member 130, first flexible part 140a and 140b, second flexible parts 150a and 150b, a third flexible part 160, and a fourth flexible part 170.

In addition, the first flexible parts 140a and 140b and the second flexible parts 150a and 150b are selectively provided with a sensing unit 180 and the third flexible part 160 and the fourth flexible part 170 are selectively provided with a driving unit 190.

More specifically, the mass body part 110, which is displaced by Coriolis force, includes a first mass body 110a and a second mass body 110b.

In addition, a second flexible part 150a is connected to the center portion of the first mass body 110a so as to correspond to the center of gravity of the first mass body 110a and the second flexible part 150b is connected to the second mass body 110b so as to be spaced apart from the center of gravity. That is, the second mass body 110b is connected to the internal frame 120 so as to be eccentric by the second flexible part 150b.

In addition, the first mass body 110a is configured of a first one side mass body 110a′ and a first other side mass body 110a″, where the first one side mass body 110a′ and the first other side mass body 110a″ have the same size and connected to each other by the coupling elastic member 130.

In addition, the first one side mass body 110a′ and the first other side mass body 110a″ are connected to the internal frame 120a by the first flexible part 140a and the second flexible part 150a, respectively.

In addition, the first one side mass body 110a′ and the first other side mass body 110a″ are displaced based on the internal frame 120a by bending of the first flexible part 140a and twisting of the second flexible part 150a when Coriolis force acts thereon. In this case, the first one side mass body 110a′ and the first other side mass body 110a″ are rotated based on the X axis with respect to the internal frame 120a. A detailed content associated with this will be described below.

Meanwhile, although the case in which the first one side mass body 110a′ and the first other side mass body 110a″ have a generally square pillar shape is shown, the first one side mass body 110a′ and the first other side mass body 110a″ are not limited to having the above-mentioned shape, but may have all shapes known in the art.

In addition, the second mass body 110b is connected to the first flexible part 140b at only one end thereof in a Y axis direction. In addition, the second mass body 110b is connected to the second flexible part 150b at the other side thereof in the X axis direction. That is, one side with respect to the Y axis direction is connected to the internal frame 120a by the first flexible part 140b and the other side is connected to the internal frame 120a by the second flexible part 150b.

In addition, the internal frame 120a is to support the mass body part 110. More specifically, the mass body part 110 may be embedded in the internal frame 120a and is each connected to the mass body part 110 by the first flexible parts 140a and 140b and the second flexible parts 150a and 150b. That is, the internal frame 120a secures a space in which the mass body part 110 may be displaced and becomes a basis when the mass body part 110 is displaced. In addition, the internal frame 120a may be formed so as to cover only a portion of the mass body part 110.

In addition, the external frame 120b supports the internal frame 120a. More specifically, the external frame 120b is provided at an outer side of the internal frame 120a so that the internal frame 120a is spaced, and is connected to the internal frame 120a by the third flexible part 160 and the fourth flexible part 170. Therefore, the internal frame 120a and the mass body part 110 connected to the internal frame 120a are supported by the external frame 120b in a floating state so as to be displaceable. In addition, the external frame 120b may be formed so as to cover only a portion of the internal frame 120a.

In addition, the sensing unit 180 and the driving unit 190 are each formed on one surface of the first flexible parts 140a and 140b and the third flexible part 160 according to a preferred embodiment of the present invention.

Hereinafter, structural characteristics, shapes, and organic coupling of each of the components of the angular velocity sensor 100 according to a first preferred embodiment of the present invention will be described in more detail.

More specifically, the internal frame 120a is partitioned into two space parts 121a and 122a so that the first mass body 110a and the second mass body 110b may be embedded.

In addition, the first one side mass body 110a′ and the first other side mass body 110a″ which are the first mass body 110a are embedded in the first space part 121a of the frame 120a and the second mass body 110b is embedded in the second space part 122b.

In addition, the internal frame 120a secures a space in which the first mass body 110a and the second mass body 110b connected by the first flexible parts 140a and 140b and the second flexible parts 150a and 150b may be displaced and becomes a basis when the first mass body 110a and the second mass body 110b are displaced.

In addition, the internal frame 120a may have a square pillar shape in which it has a square pillar shaped cavity formed at the center thereof, but is not limited thereto.

In addition, the first mass body 110a is connected to the internal frame 120a by the second flexible parts 150a and 150b in the X axis direction. In this case, one end portion of the first mass body 110a is connected to the internal frame 120a by the second flexible part 150a and the other end portions thereof facing each other are connected to each other by the coupling elastic member 130.

In addition, both end portions of the second mass body 110b are connected to the internal frame 120a by the second flexible parts 150a and 150b in the X axis direction.

In this case, the second flexible part 150a is connected to the first mass body 110a so as to correspond to the center portion, that is, the center of gravity in the Y axis direction and the second flexible part 150b is connected to the second mass body 110b so as to be spaced apart from the center portion, that is, the center of gravity in the Y axis direction.

In addition, each of the first mass body 110a and the second mass body 110b is connected to the internal frame 120a by the first flexible parts 140a and 140b in the Y axis direction. In this case, the first mass body 110a has the first flexible part 140a connected to both end portions thereof and the second mass body 110b has the first flexible part 140b connected to only one end portion thereof.

In addition, the first flexible parts 140a and 140b are beams having a predetermined thickness in a Z axis direction and made of a surface formed by the X axis and Y axis. That is, the first flexible parts 140a and 140b are formed so as to have a width W₁ in the X axis direction larger than a thickness T₁ in the Z axis direction.

In addition, the first flexible parts 140a and 140b may have the sensing unit 180 formed thereon. That is, when viewing based on the X-Y plane, since the first flexible parts 140a and 140b are relatively wide as compared to the second flexible parts 150a and 150b, the first flexible parts 140a and 140b may be provided with the sensing unit 180 sensing the displacement of the first mass body 110a and the second mass body 110b.

In addition, the sensing unit 180 may be formed in a piezoelectric scheme, a piezoresistive scheme, a capacitive scheme, an optical scheme, or the like, but is not particularly limited thereto.

In addition, the second flexible parts 150a and 150b are hinges having a predetermined thickness in the Y axis direction and having a surface formed by the X axis and the Z axis. That is, the second flexible parts 150a and 150b may be formed so as to have a width W₂ in the Z axis direction larger than a thickness T₂ in the Y axis direction.

In addition, the first flexible parts 140a and 140b and the second flexible parts 150a and 150b are disposed in a direction perpendicular to each other. That is, the first flexible parts 140a and 140b are coupled to the mass body parts 110a and 110b and the internal frame 120a in the Y axis direction, and the second flexible part 150 is coupled to the mass body part 110 and the internal frame 120a in the X axis direction.

Through the above-mentioned configuration, since the second flexible parts 150a and 150b have the width W₂ in the Z axis direction larger than the thickness T₂ in the Y axis direction, the mass bodies 110a and 110b are limited from being rotated based on the Y axis or translated in the Z axis direction, but may be relatively freely rotated based on the X axis. That is, the mass bodies 110a and 110b are embedded in the internal frame 120a and are rotated based on the X axis direction and the second flexible parts 150a and 150b serve as a hinge for the above-mentioned rotation.

In addition, the external frame 120b is provided at an outer side of the internal frame 120a so as to be spaced apart from the internal frame 120a, and is connected to the internal frame 120a by the third flexible part 160 and the fourth flexible part 170.

In addition, the external frame 120b supports the third flexible part 160 and the fourth flexible part 170 to secure a space in which the internal frame 120a may be displaced and becomes a basis when the internal frame 120a is displaced. In addition, the external frame 120b may have a square pillar shape in which it has a square pillar shaped cavity formed at the center thereof, but is not limited thereto.

In addition, the third flexible part 160 is a beam having a predetermined thickness in a Z axis direction and made of a surface formed by the X axis and the Y axis. That is, the third flexible part 160 is formed so as to have a width W₃ in the Y axis direction larger than a thickness T₃ in the Z axis direction.

Meanwhile, the third flexible part 160 may be disposed in a direction perpendicular to the first flexible parts 110a and 110b.

In addition, the third flexible part 160 has the driving unit 190 formed thereon, where the driving unit 190, which is to drive the internal frame 120a and the mass bodies 110a and 110b, may be formed in a piezoelectric scheme, a capacitive scheme, or the like.

In addition, the fourth flexible part 170 is a hinge having a predetermined thickness in the X axis direction and having a surface formed by the Y axis and the Z axis. That is, the fourth flexible part 170 is formed so as to have a width W₄ in the Z axis direction larger than a thickness T₄ in the X axis direction.

In addition, the third flexible part 160 and the fourth flexible part 170 are disposed in a direction perpendicular to each other. That is, the third flexible part 160 is coupled to the internal frame 120a and the external frame 120b in the X axis direction, and the fourth flexible part 170 is coupled to the internal frame 120a and the external frame 120b in the Y axis direction.

In addition, the third flexible part 160 and the fourth flexible part 170 connect the external frame 120b and the internal frame 120a to each other so that the internal frame 120a may be displaced based on the external frame 120b.

That is, the third flexible part 160 connects the internal frame 120a and the external frame 120b to each other in the X axis direction, and the fourth flexible part 170 connects the internal frame 120a and the external frame 120b to each other in the Y axis direction.

In addition, when viewing based on the X-Y plane, since the third flexible part 160 is relatively wide as compared to the fourth flexible part 170, the third flexible part 160 may be provided with the driving unit 190 driving the internal frame 120a.

Here, the driving unit 190 may drive the internal frame 120a so as to be rotated based on the Y axis. In this case, the driving unit 190 may be formed in a piezoelectric scheme, a capacitive scheme, or the like, but is not particularly limited thereto.

In addition, since the fourth flexible part 170 has a width W₄ in the Z axis direction larger than a thickness T₄ in the X axis direction, the internal frame 120a is limited from being rotated based on the X axis or translated in the Z axis direction, but may be relatively freely rotated based on the Y axis. That is, the internal frame 120a is fixed to the external frame 120b so as to be rotated based on the Y axis direction, and the fourth flexible part 170 serves as a hinge for the rotation of the internal frame 120a.

In addition, as the first flexible part 140, the second flexible part 150, the third flexible part 160, and the fourth flexible part 170 are disposed as describe above, the first flexible part 140 and the third flexible part 160 may be disposed in a direction perpendicular to each other. In addition, the second flexible part 150 and the fourth flexible part 170 may be disposed in a direction perpendicular to each other.

Meanwhile, the first flexible part 140 and the third flexible part 160 may be disposed to be in parallel with each other.

In addition, the second flexible parts 150a and 150b and the fourth flexible part 170 of the angular velocity sensor according to the preferred embodiment of the present invention may be formed in all possible shapes such as a hinge shape having a rectangular cross section, a torsion bar shape having a circular cross section, or the like.

In addition, the angular velocity sensor according to the first preferred embodiment of the present invention may be configured by a technical configuration forming the driving unit on the fourth flexible part, without including the third flexible part.

Hereinafter, moveable directions of the mass bodies in the angular velocity sensor according to the first preferred embodiment of the present invention will be described in detail with reference to the drawings.

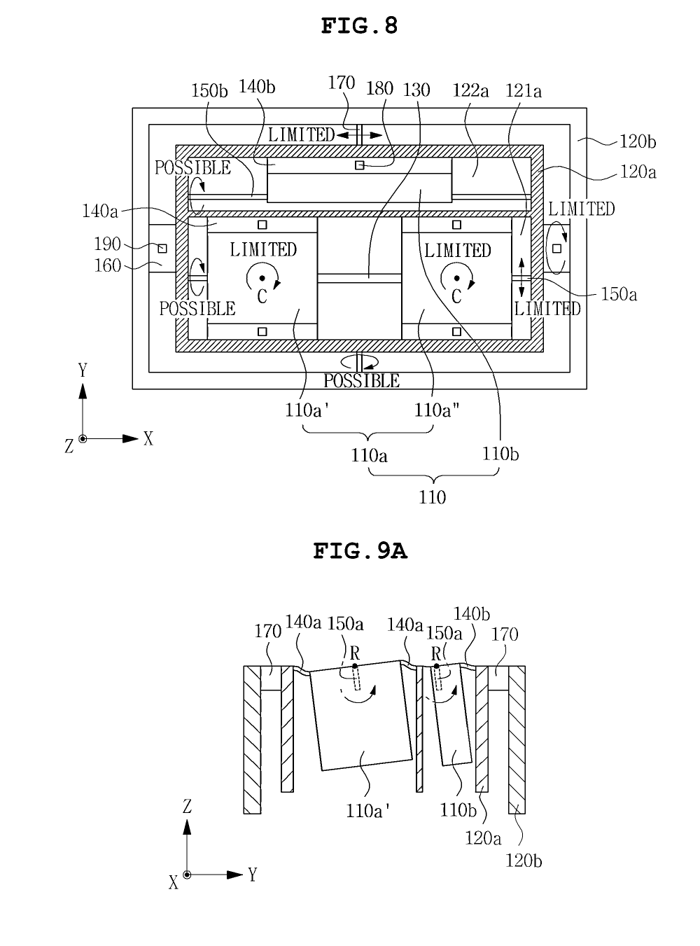

FIG. 8 is a plan view showing movable directions of a first mass body, a second mass body, and an internal frame in the angular velocity sensor shown in FIG. 4.

As shown, since the second flexible parts 150a and 150b have the width W₂ in the Z axis direction larger than the thickness T₂ in the Y axis direction, the first mass body 110a and the second mass body 110b are limited from being rotated based on the Y axis or translated in the Z axis direction, but may be relatively freely rotated based on the X axis, with respect to the internal frame 120a.

Specifically, in the case in which rigidity of the second flexible parts 150a and 150b at the time of rotation based on the Y axis is larger than rigidity of the second flexible parts 150a and 150b at the time of rotation based on the X axis, the first mass body 110a and second mass body 110b may be freely rotated based on the X axis, but are limited from being rotated based on the Y axis.

Similarly, in the case in which rigidity of the second flexible parts 150a and 150b at the time of translation in the Z axis direction is larger than the rigidity of the second flexible parts 150a and 150b at the time of the rotation based on the X axis, the first mass body 110a and the second mass body 110b may be freely rotated based on the X axis, but are limited from being translated in the Z axis direction.

Therefore, as a value of (the rigidity of the second flexible parts 150a and 150b at the time of the rotation based on the Y axis or the rigidity of the second flexible parts 150a and 150b at the time of the translation in the Z axis direction)/(the rigidity of the second flexible parts 150a and 150b at the time of the rotation based on the X axis) increases, the first mass body 110a and the second mass body 110b may be freely rotated based on the X axis, but are limited from being rotated based on the Y axis or translated in the Z axis direction, with respect to the internal frame 120a.

That is, relationships among the width W₂ of the second flexible parts 150a and 150b in the Z axis direction, a length L₁ thereof in the X axis direction, the thickness T₂ thereof in the Y axis direction, and the rigidities thereof in each direction may be represented by the following Equations.

(1) The rigidity of the second flexible parts 150a and 150b at the time of the rotation based on the Y axis or the rigidity thereof at the time of the translation in the Z axis direction is ∝W₂³×T₂/L₁³,

(2) The rigidity of the second flexible parts 150a and 150b at the time of the rotation based on the X axis is ∝T₂³×W₂/L₁.

According to the above two Equations, the value of (the rigidity of the second flexible parts 150a and 150b at the time of the rotation based on the Y axis or the rigidity of the second flexible parts 150a and 150b at the time of the translation in the Z axis direction)/(the rigidity of the second flexible parts 150a and 150b at the time of the rotation based on the X axis) is in proportion to (W₂/(T₂L₁))². However, since the second flexible parts 150a and 150b have the width W₂ in the Z axis direction larger than the thickness T₂ in the Y axis direction, (W₂/(T₂L₁))² is large, such that the value of (the rigidity of the second flexible parts 150a and 150b at the time of the rotation based on the Y axis or the rigidity of the second flexible parts 150a and 150b at the time of the translation in the Z axis direction)/(the rigidity of the second flexible parts 150a and 150b at the time of the rotation based on the X axis) increases. Due to these characteristics of the second flexible parts 150a and 150b, the first mass body 110a and the second mass body 110b are freely rotated based on the X axis, but are limited from being rotated based on the Y axis or translated in the Z axis direction, with respect to the internal frame 120a.

Meanwhile, the first flexible part 140 has relatively very high rigidity in the length direction (the Y axis direction), thereby making it possible to limit the first mass body 110a and the second mass body 110b from being rotated based on the Z axis or translated in the Y axis direction with respect to the internal frame 120a.

In addition, the second flexible parts 150a and 150b have relatively very high rigidity in the length direction (the X axis direction), thereby making it possible to limit the first mass body 110a and the second mass body 110b from being translated in the X axis direction with respect to the internal frame 120a.

As a result, due to the characteristics of the first flexible parts 140a and 140b and the second flexible parts 150a and 150b described above, the first mass body 110a and the second mass body 110b may be rotated based on the X axis, but are limited from being rotated based on the Y or Z axis or translated in the Z, Y, or X axis direction, with respect to the internal frame 120a. That is, the movable directions of the first mass body 110a and the second mass body 110b may be represented by the following Table 1.

TABLE 1

| Moveable directions of the first mass | |
|---|---|
| body and the second mass body | Whether or not movement is |
| (based on the internal frame) | possible |
| Rotation based on X axis | Possible |
| Rotation based on Y axis | Limited |
| Rotation based on Z axis | Limited |
| Translation in X axis direction | Limited |
| Translation in Y axis direction | Limited |
| Translation in Z axis direction | Limited |

As described above, since the first mass body 110a and second mass body 110b may be rotated based on the X axis, that is, the second flexible parts 150a and 150b, but are limited from being moved in the remaining directions, with respect to the internal frame 120a, the first mass body 110a and the second mass body 110b may be allowed to be displaced only with respect to force in a desired direction (the rotation based on the X axis).

As shown in FIG. 7, the first mass body 110a has the center C of gravity disposed on the same line as a rotation center R to which the second flexible part is coupled and the Y axis, while the second mass body 110b has the center C of gravity disposed so as to be spaced apart from the rotation center R to which the second flexible part 150 is coupled and the Y axis. That is, the first mass body 110a has the second flexible parts 150a and 150b connected so as to face the center of gravity of the first mass body 110a, such that both sides thereof have the same displacement based on the rotation axis, while the second mass body 110b has the second flexible parts 150a and 150b disposed so as to be spaced apart from the center portion of the second mass body 110b.

That is, the second mass body is connected to the internal frame so as to be eccentric by the second flexible part. Therefore, both sides of the second mass body 110b have different displacement based on the rotation axis.

Next, since the fourth flexible part 170 has the width W₄ in the Z axis direction larger than the thickness T₄ in the X axis direction, the internal frame 120a is limited from being rotated based on the X axis or translated in the Z axis direction, but may be relatively freely rotated based on the Y axis, with respect to the external frame 120b.

Specifically, in the case in which rigidity of the fourth flexible part 170 at the time of rotation based on the X axis is larger than rigidity of the fourth flexible part 170 at the time of rotation based on the Y axis, the internal frame 120a may be freely rotated based on the Y axis, but are limited from being rotated based on the X axis. Similarly, in the case in which rigidity of the fourth flexible part 170 at the time of translation in the Z axis direction is larger than the rigidity of the fourth flexible part 170 at the time of the rotation based on the Y axis, the internal frame 120a may be freely rotated based on the Y axis, but is limited from being translated in the Z axis direction.

Therefore, as a value of (the rigidity of the fourth flexible part 170 at the time of the rotation based on the X axis or the rigidity of the fourth flexible part 170 at the time of the translation in the Z axis direction)/(the rigidity of the fourth flexible part 170 at the time of the rotation based on the Y axis) increases, the internal frame 120a may be freely rotated based on the Y axis, but is limited from being rotated based on the X axis or translated in the Z axis direction, with respect to the external frame 120b.

That is, relationships among the width W₄ of the fourth flexible part 170 in the Z axis direction, a length L₂ thereof in the Y axis direction, the thickness T₄ thereof in the X axis direction, and the rigidities thereof in each direction may be represented by the following Equations.

(1) The rigidity of the fourth flexible part 170 at the time of the rotation based on the X axis or the rigidity thereof at the time of the translation in the Z axis direction is ∝T₄×W₄³/L₂³,

(2) The rigidity of the fourth flexible part 170 at the time of the rotation based on the Y axis is ∝T₄³W₄/L_{2.}

According to the above two Equations, the value of (the rigidity of the fourth flexible part 170 at the time of the rotation based on the X axis or the rigidity of the fourth flexible part 170 at the time of the translation in the Z axis direction)/(the rigidity of the fourth flexible part 170 at the time of the rotation based on the Y axis) is in proportion to (W₄/(T₄L₂))^{2.}

However, since the fourth flexible part 170 has the width W₄ in the Z axis direction larger than the thickness T₄ in the X axis direction, (W₄/(T₄L₂))² is large, such that the value of (the rigidity of the fourth flexible part 170 at the time of the rotation based on the X axis or the rigidity of the fourth flexible part 170 at the time of the translation in the Z axis direction)/(the rigidity of the fourth flexible part 170 at the time of the rotation based on the Y axis) increases. Due to above-mentioned characteristics of the fourth flexible part 170, the internal frame 120a is rotated based on the Y axis, but is limited from being rotated based on the X axis or translated in the Z axis direction, with respect to the external frame 120b, and is rotated only based on the Y axis.

Meanwhile, the third flexible part 160 has relatively very high rigidity in the length direction (the X axis direction), thereby making it possible to limit the internal frame 120a from being rotated based on the Z axis or translated in the Z axis direction, with respect to the external frame 120b. In addition, the fourth flexible part 170 has relatively very high rigidity in the length direction (the Y axis direction), thereby making it possible to limit the internal frame 120a from being translated in the Y axis direction, with respect to the external frame 120b (See FIG. 8).

As a result, due to the characteristics of the third flexible part 160 and the fourth flexible part 170 described above, the internal frame 120a may be rotated based on the Y axis, but is limited from being rotated based on the X or Z axis or translated in the Z, Y, or X axis direction, with respect to the external frame 120b. That is, the movable direction of the internal frame 120a may be represented by the following Table 2.

TABLE 2

| Movable direction of the internal frame | Whether or not movement is |
|---|---|
| (Based on the external frame) | possible |
| Rotation based on X axis | Limited |
| Rotation based on Y axis | Possible |
| Rotation based on Z axis | Limited |
| Translation in X axis direction | Limited |
| Translation in Y axis direction | Limited |
| Translation in Z axis direction | Limited |

As described above, since the internal frame 120a may be rotated based on the Y axis, but is limited from being moved in the remaining directions, with respect to the external frame 120b, the internal frame 120a may be allowed to be displaced only with respect to force in a desired direction (the rotation based on the Y axis).

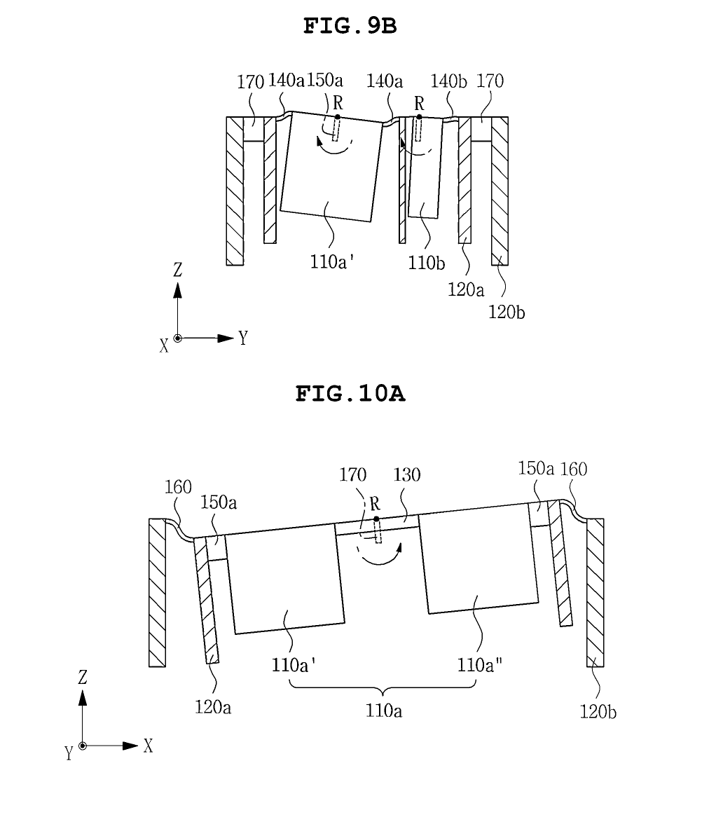

FIGS. 9A and 9B are cross-sectional views showing a process in which the first mass body and the second mass body shown in FIG. 7 are rotated based on the second flexible part with respect to an internal frame.

As shown, since the first mass body 110a is rotated in the X axis as the rotation axis R with the respect to the internal frame 120a, that is, the first mass body 110a is rotated based on an axis to which the second flexible part is coupled, with respect to the internal frame 120a, the first flexible parts 140a and 140b generate bending stress in which compressive stress and tensile stress are combined, and the second flexible parts 150a and 150b generate twisting stress based on the X axis.

In this case, in order to generate a torque in the first mass body 110a, the second flexible part 150a may be provided over the center C of gravity of the first mass body 110a based on the Z axis direction.

Meanwhile, in order to allow the first mass body 110a to be accurately rotated based on the X axis, the second flexible part 150a may be provided at a position corresponding to the center C of gravity of the first mass body 110a based on the X axis direction.

In addition, the bending stressing of the first flexible part 140a is detected by the sensing unit 180.

Next, the second mass body 110b is connected to the first flexible part 140b at only one end thereof in a Y axis direction. In addition, since the second mass body 110b is rotated in the X axis as the rotation axis R with the respect to the internal frame 120a, that is, the second mass body 110b is rotated based on an axis to which the second flexible part 150b is coupled, with respect to the internal frame 120a, the first flexible part 140b generates the bending stress in which the compressive stress and the tensile stress are combined, and the second flexible part 150b generates the twisting stress based on the X axis.

In this case, as the rotation axis R is spaced toward one side with respect to the center C of gravity of the second mass body 110b, the second mass body 110b has different displacements for one side and the other side based on the rotation axis.

In addition, the bending stressing of the first flexible part 140b is detected by the sensing unit 180.

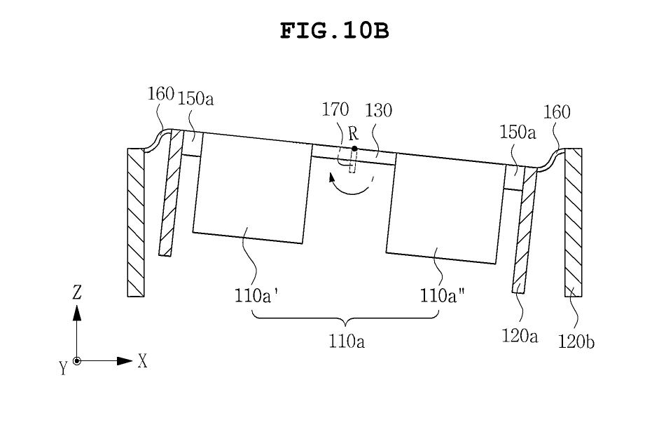

FIGS. 10A and 10B are cross-sectional views showing a process in which the internal frame shown in FIG. 6 is rotated based on a fourth flexible part with respect to an external frame.

As shown, the internal frame 120a is rotated based on the Y axis with respect to the external frame 120b, that is, is rotated based on the fourth flexible part 170 hinge-coupling the internal frame 120a to the external frame 120b, such that the third flexible part 160 generates the bending stress in which the compressive stress and the tensile stress are combined, and the fourth flexible part 170 generates the twisting stress based on the Y axis.

The angular velocity sensor according to the first preferred embodiment of the present invention is configured as described above. Hereinafter, a method of measuring an angular velocity by the angular velocity sensor 100 will be described in detail.

First, the internal frame 120a is rotated based on the Y axis with respect to the external frame 120b using the driving unit 190. In this case, the first mass bodies 110a′ and 110a″ and the second mass body 110b vibrate while being rotated together with the internal frame 120a based on the Y axis, and displacement is generated in the first mass bodies 110a′ and 110a″ and the second mass body 110b in response to the vibration.

Specifically, displacement (+X, −Z) in a +X axis direction and a −Z axis direction is generated in the first one side mass body 110a′ and at the same time, displacement (+X, +Z) in the +X axis direction and a +Z axis direction is generated in the first other side mass body 110a″. Then, displacement (−X, +Z) in a −X axis direction and the +Z axis direction is generated in the first one side mass body 110a′ and at the same time, displacement (−X, −Z) in the −X axis direction and the −Z axis direction is generated in the first other side mass body 110a″. In this case, when angular velocity rotated based on the X or Z axis is applied to the first one side mass body 110a′ and the first other side mass body 110a″, Coriolis force is generated.

Due to the Coriolis force, the first one side mass body 110a′ and the first other side mass body 110a″ are displaced while being rotated based on the X axis with respect to the internal frame 120a, and the sensing unit 180 senses the displacement of the first one side mass body 110a′ and the first other side mass body 110a″.

More specifically, when angular velocity rotated based on the X axis is applied to the first one side mass body 110a′ and the first other side mass body 110a″, Coriolis force is generated in a −Y axis direction and then generated in a +Y axis direction in the first one side mass body 110a′, and Coriolis force is generated in the +Y axis direction and then generated in the −Y axis direction in the first other side mass body 110a″.

Therefore, the first one side mass body 110a′ and the first other side mass body 110a″ are rotated based on the X axis in directions opposite to each other, the sensing unit 180 may sense the displacement of the first one side mass body 110a′ and the first other side mass body 110a″ to calculate the Coriolis force, and the angular velocity rotated based on the X axis may be measured through the Coriolis force.

Meanwhile, when signals each generated in the first flexible part 140a each connected to both end portions of the first one side mass body 110a′ and the sensing unit 180 are defined as SY1 and SY2 and signals each generated in the first flexible part 140a each connected to both end portions of the first other side mass body 110a″ and the first sensing unit 180 are defined as SY3 and SY4, the angular velocity rotated based on the X axis direction may be calculated from (SY1−SY2)−(SY3−SY4). As described above, since the signals are differentially output between the first one side mass body 110a′ and the first other side mass body 110a″ rotated in the directions opposite to each other, acceleration noise may be offset.

In addition, when angular velocity rotated based on the Z axis is applied to the first one side mass body 110a′ and the first other side mass body 110a″, the Coriolis force is generated in the −Y axis direction and then generated in the +Y axis direction in the first one side mass body 110a′, and the Coriolis force is generated in the −Y axis direction and then generated in the +Y axis direction in the first other side mass body 110a″. Therefore, the first one side mass body 110a′ and the first other side mass body 110a″ are rotated based on the X axis in the same direction as each other, the sensing unit 180 may sense the displacement of the first one side mass body 110a′ and the first other side mass body 110a″ to calculate the Coriolis force, and the angular velocity rotated based on the Z axis may be measured through the Coriolis force.

In this case, when signals each generated in two first flexible parts 140a each connected to both end portions of the first one side mass body 110a′ and the sensing unit 180 are defined as SY1 and SY2 and signals each generated in the first flexible part 140b each connected to both end portions of the first other side mass body 110a″ and the sensing unit 180 are defined as SY3 and SY4, the angular velocity rotated based on the Z axis may be calculated from (SY1−SY2)+(SY3−SY4).

In addition, an example of calculating the angular velocity according to the above-mentioned definition is as follows.

As described above, when the internal frame 120a is rotated based on the Y axis with respect to the external frame 120b by the driving unit 190, the first mass body 110a is vibrated while being rotated based on the Y axis together with the internal frame 120a and the first mass body 110a generates velocity (Vₓ, V_{z}) in the X axis and the Z axis directions in response to the vibration. In this case, when angular velocity (Ω_{Z}, Ω_{X}) based on the Z axis or the X axis is applied to the first mass body 110a, Coriolis force F_{y} is generated in the Y axis direction.

Due to the Coriolis force F_{y}, the first mass body 110a is displaced while being rotated based on the X axis with respect to the internal frame 120a, and the sensing unit 180 senses the displacement of the first mass body 110a. In addition, the Coriolis force F_{y} may be calculated by sensing the displacement of the first mass body 110a.

Therefore, angular velocity Ω_{X} based on the X axis may be calculated through the Coriolis force F_{y} from F_{y}=2mV_{z}Ω_{X} and angular velocity Ω_{Z} based on the Z axis may be calculated through the Coriolis force F_{y} from F_{y}=2mV_{z}Ω_{X}.

As a result, the angular velocity sensor 100 according to the first preferred embodiment of the present embodiment may measure the angular velocity rotated based on the X or Z axis through the first mass body 110a and the sensing unit 180.

Next, angular velocity detection according to the second mass body is as follows.

First, the internal frame 120a is rotated based on the Y axis with respect to the external frame 120b using the driving unit 190.

In this case, the second mass body 110b is vibrated while being rotated based on the Y axis together with the internal frame 120a similar to the first mass body 110a, and may be rotated only based on the X axis with the internal frame 120a due to the characteristics of the first flexible part 140 and the second flexible part 150 described above in response to the vibration.

That is, even though the internal frame 120a is rotated based on the Y axis with respect to the external frame 120b using the driving unit 190, the second mass body 110b is not rotated based on the Y axis with respect to the internal frame 120a.

In addition, due to the characteristics of the third flexible part 160 and the fourth flexible part 170 described above, the internal frame 120a may be rotated only based on the Y axis with respect to the external frame 120b. Therefore, as shown in FIG. 13, when the displacement of the second mass body 110b is sensed using the sensing unit 180, even though the Coriolis force in the Y axis direction acts, the internal frame 120a is not rotated based on the X axis with respect to the external frame 120b, and only the second mass body 110b is rotated based on the X axis with respect to the internal frame 120a.

In addition, the second mass body 110b is connected to the second flexible part 150 so as to be eccentric with respect to the center C of gravity, only one end with respect to the Y axis is connected to the first flexible part 140 having the sensing unit mounted thereon, and the other end portion with respect to the Y axis is connected to the second flexible part 150 serving as the hinge of the rotation movement, such that the second mass body 110b is rotated based on the X axis with respect to the internal frame 120a as described above.

When the internal frame 120a is rotated based on the Y axis with respect to the external frame 120b by the driving unit 190, the second mass body 110b is vibrated while being rotated based on the Y axis together with the internal frame 120a and the second mass body 110b generates velocity V, in the X axis direction in response to the vibration. In this case, when angular velocity Ω_{y} or Ω_{z} based on the Y or Z axis is applied to the second mass body 110b, the Coriolis force (F_{z}, F_{y}) generates in the Z or Y axis, where the Coriolis force generates a displacement rotating the second mass body 110b based on the X axis with the respect to the internal frame 120a.

The sensing unit 180 may calculate the Coriolis force by sensing the displacement of the second mass body 110b, a sum of the angular velocity Ω_{y} in the Y axis direction and the angular velocity Ω_{z} in the Z axis direction is detected through the Coriolis force, and the angular velocity Ω_{y} in the Y axis direction may be calculated by subtracting the angular velocity Ω_{z} in the Z axis direction measured by the center mass body 110 and the sensing unit 180 from the sum.

Through the above-mentioned configuration, the angular velocity sensor 100 according to the first preferred embodiment of the present invention is implemented as the angular velocity sensor capable of detecting the angular velocity in three axes by detecting the angular velocity in the X axis direction and the angular velocity in the Z axis direction by the first mass body 110a and detecting the angular velocity in the Y axis direction by the second mass body 110b.

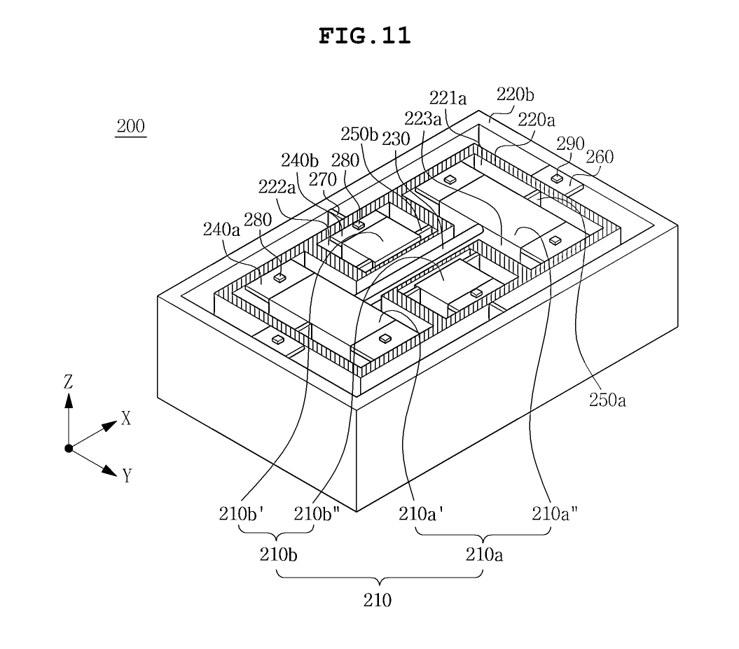

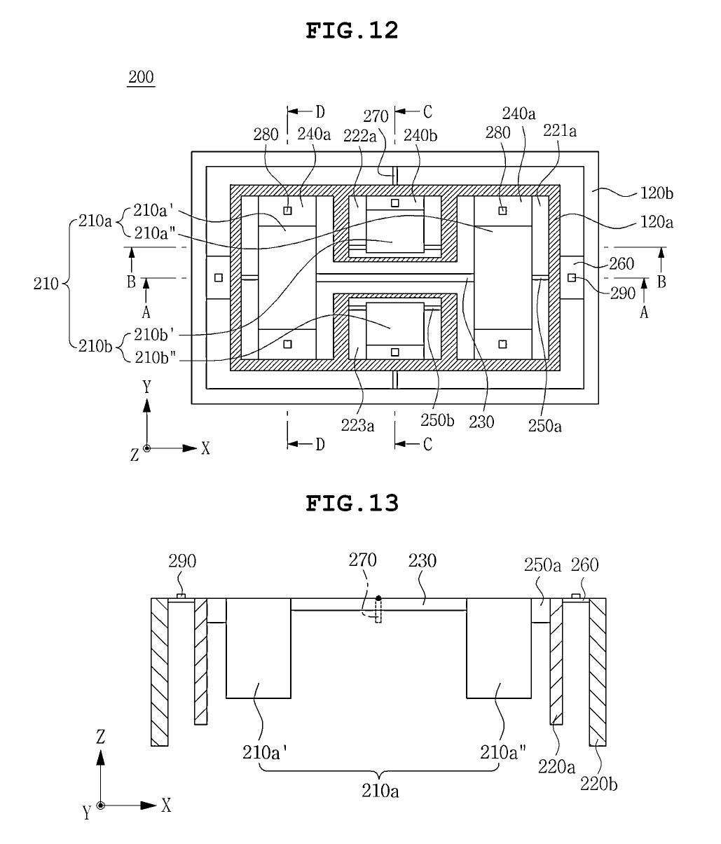

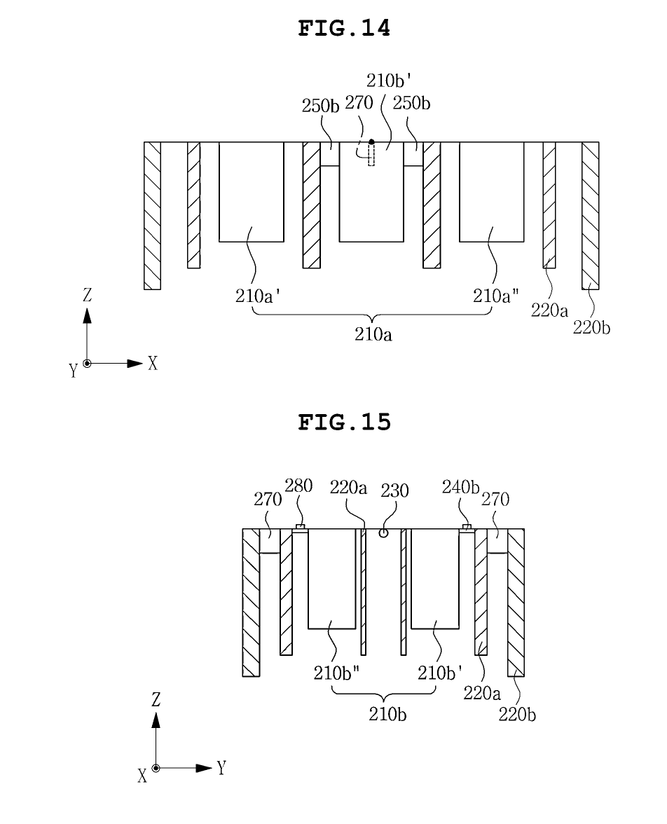

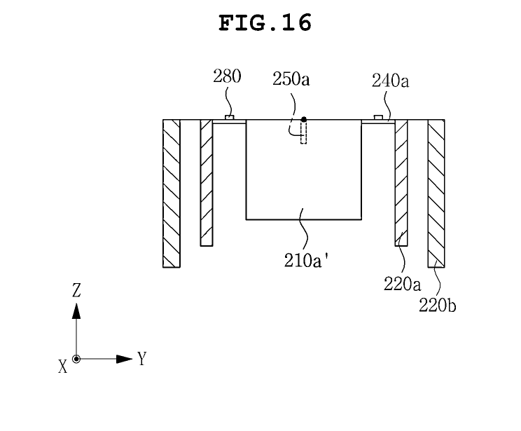

FIG. 11 is a perspective view schematically showing an angular velocity sensor according to a second preferred embodiment of the present invention, FIG. 12 is a plan view of the angular velocity sensor shown in FIG. 11, FIG. 13 is a schematic cross-sectional view taken along a line A-A of the angular velocity sensor shown in FIG. 12, FIG. 14 is a schematic cross-sectional view taken along a line B-B of the angular velocity sensor shown in FIG. 12, FIG. 15 is a schematic cross-sectional view taken along a line C-C of the angular velocity sensor shown in FIG. 12, and FIG. 16 is a schematic cross-sectional view taken along a line D-D of the angular velocity sensor shown in FIG. 12.

As shown, the angular velocity sensor 200 has a difference only in the second mass body as compared to the angular velocity sensor 100 shown in FIG. 3. More specifically, a second mass body 210b of the angular velocity sensor 200 is configured of a second one side mass body 210b′ and a second other side mass body 210b″.

Hereinafter, technical configuration and organic coupling of the angular velocity sensor 200 according to the second preferred embodiment of the present invention will be described in more detail.

As shown, the angular velocity sensor 200 is configured to include a mass body part 210, an internal frame 220a, an external frame 220b, a coupling elastic member 230, first flexible parts 240a and 240b, second flexible parts 250a and 250b, a third flexible part 260, and a fourth flexible part 270.

In addition, the first flexible parts 240a and 240b and the second flexible parts 250a and 250b are selectively provided with a sensing unit 280 and the third flexible part 260 and the fourth flexible part 270 are selectively provided with a driving unit 290.

More specifically, the mass body part 210, which is displaced by Coriolis force, includes a first mass body 210a and a second mass body 210b.

In addition, the second flexible part 250a is connected to the center portion of the first mass body 210a so as to correspond to the center of gravity of the first mass body 210a and the second flexible part 250b is connected to the second mass body 210b so as to be spaced apart from the center of gravity. That is, the second mass body 210b is connected to the internal frame 220a so as to be eccentric by the second flexible part 250b.

In addition, the first mass body 210a is configured of a first one side mass body 210a′ and a first other side mass body 210a″, where the first one side mass body 210a′ and the first other side mass body 210a″ have the same size and connected to each other by the coupling elastic member 230.

In addition, the first one side mass body 210a′ and the first other side mass body 210a″ are connected to the internal frame 220a by the first flexible part 240a and the second flexible part 250a, respectively.

In addition, the first one side mass body 210a′ and the first other side mass body 210a″ are displaced based on the internal frame 220a by bending of the first flexible part 240a and twisting of the second flexible part 250a when Coriolis force acts thereon. In this case, the first one side mass body 210a′ and the first other side mass body 210a″ are rotated based on the X axis with respect to the internal frame 220a as described above through the angular velocity sensor according to the first preferred embodiment of the present invention.

Next, the second mass body 210b is configured of a second one side mass body 210b′ and a second other side mass body 210b″, where the second one side mass body 210b′ and the second other side mass body 210b″ may be have the same size.

In addition, the second one side mass body 210b′ and the second other side mass body 210b″ are disposed between the first one side mass body 210a′ and the first other side mass body 210a″ connected to the coupling elastic member 130. That is, the second one side mass body 210b′ and the second other side mass body 210b″ are disposed so as to be opposite to each other based on the coupling elastic member 130 between the first one side mass body 210a′ and the first other side mass body 210a″.

In addition, the second one side mass body 210b′ and the second other side mass body 210b″ are each connected to the first flexible part 240b at only one end thereof in a Y axis direction. In addition, the second one side mass body 210b′ and the second other side mass body 210b″ are each connected to the second flexible part 250b at the other side thereof in the X axis direction. That is, one side of the second one side mass body 210b′ and the second other side mass body 210b″ with respect to the Y axis direction is connected to the internal frame 220a by the first flexible part 240b and the other side of the second one side mass body 210b′ and the second other side mass body 210b″ is connected to the internal frame 220a by the second flexible part 250b.

In addition, the internal frame 220a is to support the mass body part 210. More specifically, the mass body part 210 may be embedded in the internal frame 220a and is each connected to the mass body part 210 by the first flexible parts 240a and 240b and the second flexible parts 250a and 250b. That is, the internal frame 220a secures a space in which the mass body part 110 may be displaced and becomes a basis when the mass body part 210 is displaced. In addition, the internal frame 220a may be formed so as to cover only a portion of the mass body part 210.

In addition, the internal frame 220a is partitioned into three space parts 221a, 222a, and 223a so that the first mass body 210a, the second one side mass body 210b′, and the second other side mass body 210b″ may be embedded.

In addition, the first one side mass body 210a′ and the first other side mass body 210a″ which are the first mass body 210a are embedded in the first space part 221a of the internal frame 220a, the second one side mass body 210b′ is embedded in the second space part 222b, and the second other side mass body 210b″ is embedded in the third space part 223b.

In addition, the internal frame 220a secures a space in which the first mass body 210a and the second mass body 210b connected by the first flexible parts 240a and 240b and the second flexible parts 250a and 250b may be displaced and becomes a basis when the first mass body 210a and the second mass body 210b are displaced.

In addition, the first mass body 210a is connected to the internal frame 220a by the second flexible parts 250a and 250b in the X axis direction. In this case, one end portion of the first mass body 210a is each connected to the internal frame 220a by the second flexible part 250a and the other end portions thereof facing each other are connected to each other by the coupling elastic member 230. In addition, both end portions of the second mass body 210b are connected to the internal frame 220a by the second flexible parts 250a and 250b in the X axis direction.

In this case, the second flexible part 250a is connected to the first mass body 210a so as to correspond to the center portion, that is, the center of gravity in the Y axis direction and the second flexible part 250b is connected to the second mass body 210b so as to be spaced apart from the center portion, that is, the center of gravity in the Y axis direction.

In addition, each of the first mass body 210a and the second mass body 210b is connected to the internal frame 220a by the first flexible parts 240a and 240b in the Y axis direction. In this case, the first mass body 210a has the first flexible part 240a connected to both end portions thereof and the second mass body 210b has the first flexible part 240b connected to only one end portion thereof.

In addition, the external frame 220b supports the internal frame 220a. More specifically, the external frame 220b is provided at an outer side of the internal frame 220a so that the internal frame 220a is spaced, and is connected to the internal frame 220a by the third flexible part 260 and the fourth flexible part 270. Therefore, the internal frame 220a and the mass body part 210 connected to the internal frame 220a are supported by the external frame 220b in a floating state so as to be displaceable. In addition, the external frame 220b may be formed so as to cover only a portion of the internal frame 220a.

In addition, the sensing unit 280 and the driving unit 290 are each formed on one surface of the first flexible parts 240a and 240b and the third flexible part 260 according to a preferred embodiment of the present invention.

In addition, the external frame 220b is provided at an outer side of the internal frame 220a so as to be spaced apart from the internal frame 220a, and is connected to the internal frame 220a by the third flexible part 260 and the fourth flexible part 270.

In addition, the external frame 220b supports the third flexible part 260 and the fourth flexible part 270 to secure a space in which the internal frame 220a may be displaced and becomes a basis when the internal frame 220a is displaced. In addition, the external frame 220b may have a square pillar shape in which it has a square pillar shaped cavity formed at the center thereof, but is not limited thereto.

The shapes and the driving of the first flexible parts 240a and 240b, the second flexible parts 250a and 250b, the third flexible part 260, and the fourth flexible part 270 of the angular velocity sensor 200 according to the second preferred embodiment of the present invention are equal to those of the angular velocity sensor 100 according to the first preferred embodiment of the present invention. Therefore, since a description thereof is described above, it will be omitted.

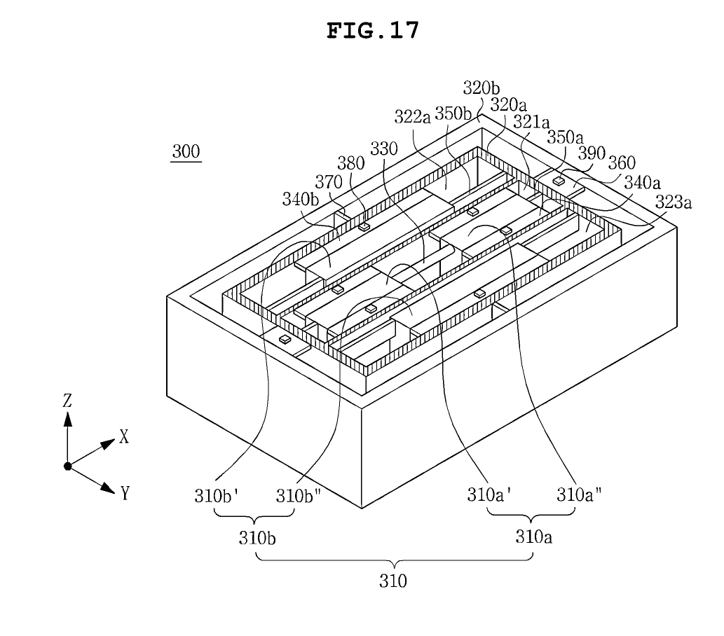

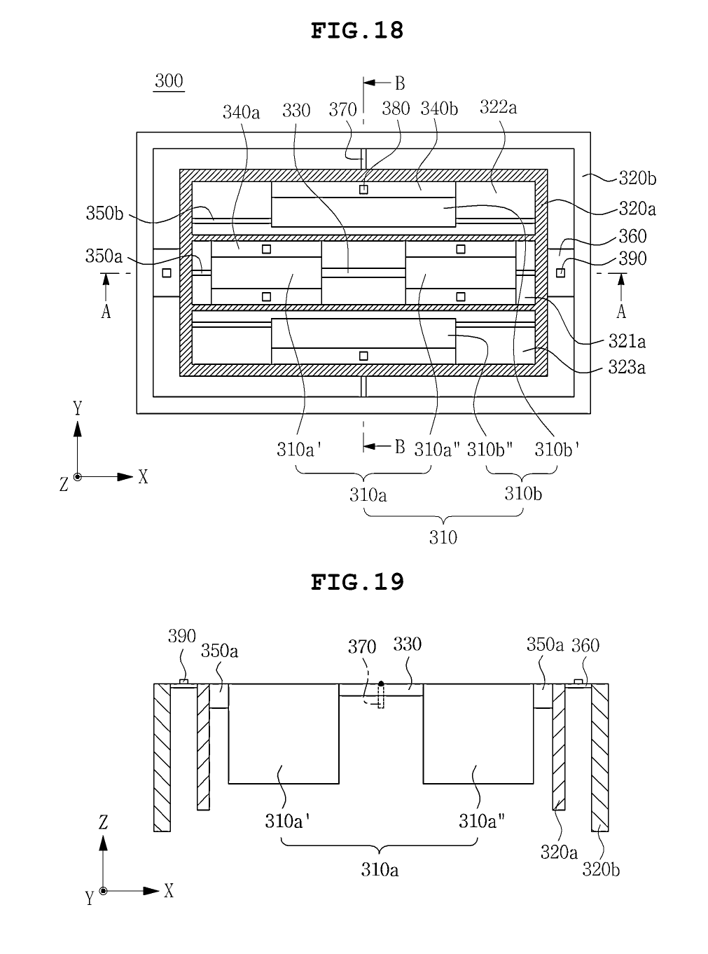

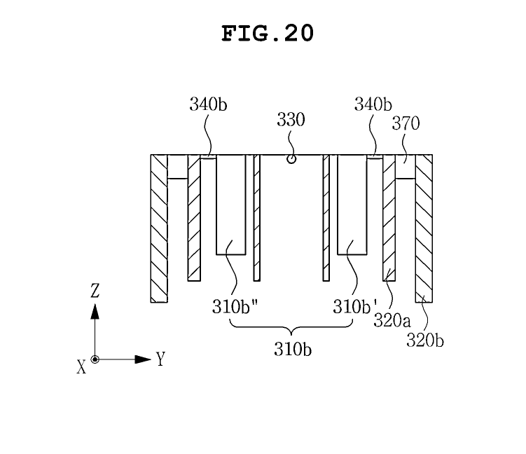

FIG. 18 is a plan view of the angular velocity sensor shown in FIG. 17, FIG. 19 is a schematic cross-sectional view taken along a line A-A of the angular velocity sensor shown in FIG. 18, and FIG. 20 is a schematic cross-sectional view taken along a line B-B of the angular velocity sensor shown in FIG. 18.

As shown, the angular velocity sensor 300 has a difference only in a second mass body as compared to the angular velocity sensor 100 shown in FIG. 3. More specifically, a second mass body 310b of the angular velocity sensor 300 is configured of a second one side mass body 310b′ and a second other side mass body 310b″. That is, the second mass body 310b is configured to further include the second other side mass body 210b″ as compared to the angular velocity sensor 100.

Hereinafter, technical configuration and organic coupling of the angular velocity sensor 300 according to the third preferred embodiment of the present invention will be described in more detail.

As shown, the angular velocity sensor 300 is configured to include a mass body part 310, an internal frame 320a, an external frame 320b, a coupling elastic member 330, first flexible parts 340a and 340b, second flexible parts 350a and 350b, a third flexible part 360, and a fourth flexible part 370.

In addition, the first flexible parts 340a and 340b and the second flexible parts 350a and 350b are selectively provided with a sensing unit 380 and the third flexible part 360 and the fourth flexible part 370 are selectively provided with a driving unit 390.

More specifically, the mass body part 310, which is displaced by Coriolis force, includes a first mass body 310a and a second mass body 310b.

In addition, the second flexible part 350a is connected to the center portion of the first mass body 310a so as to correspond to the center of gravity of the first mass body 310a and the second flexible part 350b is connected to the second mass body 310b so as to be spaced apart from the center of gravity. That is, the second mass body 310b is connected to the internal frame 320a so as to be eccentric by the second flexible part 350b.

In addition, the first mass body 310a is configured of a first one side mass body 310a′ and a first other side mass body 310a″, where the first one side mass body 310a′ and the first other side mass body 310a″ have the same size and connected to each other by the coupling elastic member 330.

In addition, each of the first one side mass body 310a′ and the first other side mass body 310a″ is connected to the internal frame 320a by the first flexible part 340a and the second flexible part 350a.

In addition, the first one side mass body 310a′ and the first other side mass body 310a″ are displaced based on the internal frame 320a by bending of the first flexible part 340a and twisting of the second flexible part 350a when Coriolis force acts thereon. In this case, the first one side mass body 310a′ and the first other side mass body 310a″ are rotated based on the X axis with respect to the internal frame 320a as described above through the angular velocity sensor according to the first preferred embodiment of the present invention.

Next, the second mass body 310b is configured of a second one side mass body 310b′ and a second other side mass body 310b″, where the second one side mass body 310b′ and the second other side mass body 310b″ may be have the same size.

In addition, the second one side mass body 310b′ and the second other side mass body 310b″ are each disposed at one side and the other side of the first one side mass body 310a′ and the first other side mass body 310a″ connected to the coupling elastic member 330. That is, the second one side mass body 310b′ and the second other side mass body 310b″ are disposed so as to be opposite to each other based on the first one side mass body 310a′ and the first other side mass body 310a″ connected by the coupling elastic member 330.

In addition, the second one side mass body 310b′ and the second other side mass body 310b″ are each connected to the first flexible part 340b at only one end thereof in a Y axis direction. In addition, the second one side mass body 310b′ and the second other side mass body 310b″ are each connected to the second flexible part 350b at the other side thereof in the X axis direction. That is, one side of the second one side mass body 310b′ and the second other side mass body 310b″ with respect to the Y axis direction is connected to the internal frame 320a by the first flexible part 340b and the other side of the second one side mass body 310b′ and the second other side mass body 310b″ is connected to the internal frame 320a by the second flexible part 350b.

In addition, the first mass body 310a may be disposed between the second one side mass body 310b′ and the second other side mass body 310b″.

In addition, the internal frame 320a is to support the mass body part 310. More specifically, the mass body part 310 may be embedded in the internal frame 320a and is each connected to the mass body part 310 by the first flexible parts 340a and 340b and the second flexible parts 350a and 350b. That is, the internal frame 320a secures a space in which the mass body part 310 may be displaced and becomes a basis when the mass body part 310 is displaced. In addition, the internal frame 320a may be formed so as to cover only a portion of the mass body part 310.

In addition, the internal frame 320a is partitioned into three space parts 321a, 322a, and 323a so that the first mass body 310a, the second one side mass body 310b′, and the second other side mass body 310b″ may be embedded.

In addition, the first one side mass body 310a′ and the first other side mass body 310a″ which are the first mass body 310a are embedded in the first space part 321a of the internal frame 320a, the second one side mass body 310b′ is embedded in the second space part 322b, and the second other side mass body 310b″ is embedded in the third space part 323a.

In addition, the first mass body 310a is connected to the internal frame 320a by the second flexible parts 350a and 350b in the X axis direction. In this case, one end portion of the first mass body 310a is each connected to the internal frame 320a by the second flexible part 350a and the other end portions thereof facing each other are connected to each other by the coupling elastic member 330.

In addition, both end portions of the second mass body 310b are connected to the internal frame 320a by the second flexible parts 350a and 350b in the X axis direction.

In this case, the second flexible part 350a is connected to the first mass body 310a so as to correspond to the center portion, that is, the center of gravity in the Y axis direction and the second flexible part 350b is connected to the second mass body 310b so as to be spaced apart from the center portion, that is, the center of gravity in the Y axis direction.

In addition, each of the first mass body 310a and the second mass body 310b is connected to the internal frame 320a by the first flexible parts 340a and 340b in the Y axis direction. In this case, the first mass body 310a has the first flexible part 340a connected to both end portions thereof and the second mass body 310b has the first flexible part 340b connected to only one end portion thereof.

In addition, the external frame 320b supports the internal frame 320a. More specifically, the external frame 320b is provided at an outer side of the internal frame 320a so that the internal frame 320a is spaced, and is connected to the internal frame 320a by the third flexible part 360 and the fourth flexible part 370. Therefore, the internal frame 320a and the mass body part 310 connected to the internal frame 320a are supported by the external frame 320b in a floating state so as to be displaceable. In addition, the external frame 320b may be formed so as to cover only a portion of the internal frame 320a.

In addition, the sensing unit 380 and the driving unit 390 are each formed on one surface of the first flexible parts 340a and 340b and the third flexible part 360 according to a preferred embodiment of the present invention.

In addition, the external frame 320b is provided at an outer side of the internal frame 320a so as to be spaced apart from the internal frame 320a, and is connected to the internal frame 320a by the third flexible part 360 and the fourth flexible part 370.

The shapes and the driving of the first flexible parts 340a and 340b, the second flexible parts 350a and 350b, the third flexible part 360, and the fourth flexible part 370 of the angular velocity sensor 300 according to the third preferred embodiment of the present invention are equal to those of the angular velocity sensor 100 according to the first preferred embodiment of the present invention. Therefore, since a description thereof is described above, it will be omitted.

According to the preferred embodiments of the present invention, the detection module for the sensor capable of integrating a sensing mode by mechanically coupling the plurality of mass bodies and having characteristics such as high sensitivity, low off-axis sensitivity, low noise, and low drift, and the angular velocity sensor having the same may be provided, the detection module for a sensor capable of simultaneously detecting physical amounts for multiple axes by generating different displacements by including the first mass body connected to correspond to the center of gravity and the second mass body connected to be spaced apart from the center of gravity, a driving part integral type angular velocity sensor capable removing interference between a driving mode and a sensing mode and decreasing an effect caused by a manufacturing error by including a plurality of frames and driving the frames and the mass body by one driving part to individually generate driving displacement and sensing displacement of the mass body and forming a flexible part so that the mass body is movable only in a specific direction may be provided, and the angular velocity sensor capable of removing interference between a driving mode and a sensing mode and decreasing an effect caused by a manufacturing error by including a plurality of frames and driving the frames and the mass body by one driving part to individually generate driving displacement and sensing displacement of the mass body and forming a flexible part so that the mass body is movable only in a specific direction and detecting the angular velocity of the three axes by the mass body included in the frame including the first mass body connected to correspond to the center of gravity and the second mass body connected to be spaced apart from the center of gravity and different driving and displacements of the first mass body and the second mass body caused by the frame driving may be obtained.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A detection module for a sensor, comprising:
a mass body part including a first mass body including a first one side mass body and a first other side mass body connected to each other by a coupling elastic member, and a second mass body;
a frame supporting the first mass body and the second mass body;
first flexible parts each connecting the first mass body and the second mass body to the frame; and
second flexible parts each connecting the first mass body and the second mass body to the frame,
wherein the second flexible parts are connected to the first mass body so as to correspond to the center of gravity of the first mass body and the second mass body is connected to the frame so as to be eccentric by the second flexible part.

2. The detection module for the sensor as set forth in claim 1, wherein one end portion of the first one side mass body and the first other side mass body are each connected to the frame by the second flexible parts and the other end portions thereof facing each other are connected to each other by the coupling elastic member.

3. The detection module for the sensor as set forth in claim 1, wherein the first flexible part and the second flexible part are disposed in a direction perpendicular to each other.

4. The detection module for the sensor as set forth in claim 1, wherein the first flexible part is a beam having a surface formed by one axis direction and the other axis direction, and having a thickness extended to a direction perpendicular to the surface.

5. The detection module for the sensor as set forth in claim 1, wherein the second flexible part is a hinge having a thickness in one axis direction and having a surface formed in the other axis direction.

6. The detection module for the sensor as set forth in claim 1, wherein one surface of the first flexible parts or the second flexible parts is selectively provided with a sensing unit sensing a displacement of the first mass body and the second mass body.

7. An angular velocity sensor, comprising:
a mass body part including a first mass body including a first one side mass body and a first other side mass body connected to each other by a coupling elastic member, and a second mass body;
an internal frame supporting the first mass body and the second mass body;
first flexible parts each connecting the first mass body and the second mass body to the internal frame;
second flexible parts each connecting the first mass body and the second mass body to the internal frame;
an external frame supporting the internal frame;
a third flexible part connecting the internal frame and the external frame to each other; and
a fourth flexible part connecting the internal frame and the external frame to each other,
wherein the second flexible parts are connected to the first mass body so as to correspond to the center of gravity of the first mass body and the second mass body is connected to the internal frame so as to be eccentric by the second flexible part.

8. The angular velocity sensor as set forth in claim 7, wherein one end portion of the first one side mass body and the first other side mass body are each connected to the internal frame by the second flexible parts and the other end portions thereof facing each other are connected to each other by the coupling elastic member.

9. The angular velocity sensor as set forth in claim 7, wherein the first flexible part and the second flexible part are disposed in a direction perpendicular to each other.

10. The angular velocity sensor as set forth in claim 7, wherein the third flexible part and the fourth flexible part are disposed in a direction perpendicular to each other.

11. The angular velocity sensor as set forth in claim 7, wherein the third flexible part is disposed in a direct perpendicular to the first flexible part.

12. The angular velocity sensor as set forth in claim 7, wherein the fourth flexible part is disposed in a direct perpendicular to the second flexible part.

13. The angular velocity sensor as set forth in claim 7, wherein the first flexible part is a beam having a surface formed by one axis direction and the other axis direction, and a thickness extended to a direction perpendicular to the surface.

14. The angular velocity sensor as set forth in claim 13, wherein the first flexible part is a beam having a predetermined thickness in a Z axis direction and configured by a surface formed by an X axis and a Y axis and is formed to have a width W₁ in an X axis direction larger than a thickness T₁ in the Z axis direction.

15. The angular velocity sensor as set forth in claim 13, wherein the first flexible parts are connected between one end of the second mass body and the internal frame in a Y axis direction.

16. The angular velocity sensor as set forth in claim 7, wherein one surface of the first flexible parts or the second flexible parts is selectively provided with a sensing unit sensing a displacement of the first mass body and the second mass body.

17. The angular velocity sensor as set forth in claim 7, wherein the second flexible part is a hinge having a thickness in one axis direction and a surface formed in the other axis direction.

18. The angular velocity sensor as set forth in claim 17, wherein the second flexible part is a hinge having a predetermined thickness in a Y axis direction and a surface formed by an X axis and a Z axis and is formed to have a width W₂ in a Z axis direction larger than a thickness T₂ in the Y axis direction.

19. The angular velocity sensor as set forth in claim 18, wherein the second flexible part has a hinge shape having a rectangular cross section or a torsion bar shape having a circular cross section.

20. The angular velocity sensor as set forth in claim 7, wherein the third flexible part is a beam having a surface formed by one axis direction and the other axis direction, and a thickness extended to a direction perpendicular to the surface.

21. The angular velocity sensor as set forth in claim 20, wherein the third flexible part is a beam having a predetermined thickness in a Z axis direction and configured by a surface formed by an X axis and a Y axis and is formed to have a width W₃ in a Y axis direction larger than a thickness T₃ in the Z axis direction.

22. The angular velocity sensor as set forth in claim 7, wherein the fourth flexible part is a hinge having a thickness in one axis direction and a surface formed in the other axis direction.

23. The angular velocity sensor as set forth in claim 22, wherein the fourth flexible part is a hinge having a predetermined thickness in an X axis direction and configured by a surface formed by an Y axis and a Z axis and is formed to have a width W₄ in a Z axis direction larger than a thickness T₄ in the X axis direction.

24. The angular velocity sensor as set forth in claim 7, wherein one surface of the third flexible parts or the fourth flexible parts is selectively provided with a driving unit driving the internal frame.

25. The angular velocity sensor as set forth in claim 24, wherein when the internal frame is driven by the driving unit of the third flexible part, the internal frame is rotated based on an axis to which the fourth flexible part is coupled, with respect to the external frame.

26. The angular velocity sensor as set forth in claim 25, wherein when the internal frame is rotated based on the axis to which the fourth flexible part is coupled, the third flexible part generates bending stress and the fourth flexible part generates twisting stress.

27. The angular velocity sensor as set forth in claim 26, wherein when the internal frame is rotated based on the axis to which the fourth flexible part is coupled, the first mass body and the second mass body are rotated based on an axis to which the second flexible parts are coupled, with respect to the internal frame.

28. The angular velocity sensor as set forth in claim 27, wherein when the first mass body and the second mass body are rotated, the first flexible parts generate the bending stress and the second flexible parts generate the twisting stress.

29. The angular velocity sensor as set forth in claim 7, wherein the second mass body has one end portion to which the first flexible parts are connected, in a Y axis direction and the other end portion to which the second flexible parts are connected, in an X axis direction.

30. An angular velocity sensor, comprising:
a mass body part including a first mass body configured of a first one side mass body and a first other side mass body connected to each other by a coupling elastic member, and a second mass body configured of a second one side mass body and a second other side mass body disposed to face each other based on the coupling elastic member;
an internal frame supporting the first mass body and the second mass body;
first flexible parts each connecting the first mass body and the second mass body to the internal frame;
second flexible parts each connecting the first mass body and the second mass body to the internal frame;
an external frame supporting the internal frame;
a third flexible part connecting the internal frame and the external frame to each other; and
a fourth flexible part connecting the internal frame and the external frame to each other,
wherein the second flexible parts are connected to the first mass body so as to correspond to the center of gravity of the first mass body and the second mass body is connected to the internal frame so as to be eccentric by the second flexible parts.

31. The angular velocity sensor as set forth in claim 30, wherein one end portion of the first one side mass body and the first other side mass body are each connected to the internal frame by the second flexible parts and the other end portions thereof facing each other are connected to each other by the coupling elastic member.

32. The angular velocity sensor as set forth in claim 30, wherein the internal frame is provided with a first space part in which the first one side mass body and the first other side mass body are embedded, a second space part in which the second one side mass body is embedded, and a third space part in which the second other side mass body is embedded.

33. The angular velocity sensor as set forth in claim 30, wherein the first flexible part is a beam having a surface formed by one axis direction and the other axis direction and having a thickness extended to a direction perpendicular to the surface, and the second flexible part is a hinge having a thickness in one axis direction and having a surface formed in the other axis direction.

34. The angular velocity sensor as set forth in claim 33, wherein one surface of the first flexible parts or the second flexible parts is selectively provided with a sensing unit sensing a displacement of the first mass body and the second mass body.

35. The angular velocity sensor as set forth in claim 30, wherein the third flexible part is a beam having a surface formed by one axis direction and the other axis direction and having a thickness extended to a direction perpendicular to the surface, and the fourth flexible part is a hinge having a thickness in one axis direction and having a surface formed in the other axis direction.

36. The angular velocity sensor as set forth in claim 35, wherein one surface of the third flexible part or the fourth flexible part is selectively provided with a driving unit driving the internal frame.

37. An angular velocity sensor, comprising:
a mass body part including a first mass body configured of a first one side mass body and a first other side mass body connected to each other by a coupling elastic member, and a second mass body configured of a second one side mass body and a second other side mass body disposed to face each other based on the first mass body;
an internal frame supporting the first mass body and the second mass body;
first flexible parts each connecting the first mass body and the second mass body to the internal frame;
second flexible parts each connecting the first mass body and the second mass body to the internal frame;
an external frame supporting the internal frame;
a third flexible part connecting the internal frame and the external frame to each other; and
a fourth flexible part connecting the internal frame and the external frame to each other,
wherein the second flexible parts are connected to the first mass body so as to correspond to the center of gravity of the first mass body and the second mass body is connected to the internal frame so as to be eccentric by the second flexible parts.

38. The angular velocity sensor as set forth in claim 37, wherein one end portion of the first one side mass body and the first other side mass body are each connected to the internal frame by the second flexible parts and the other end portions thereof facing each other are connected to each other by the coupling elastic member.

39. The angular velocity sensor as set forth in claim 37, wherein the internal frame is provided with a first space part in which the first one side mass body and the first other side mass body are embedded, a second space part in which the second one side mass body is embedded, and a third space part in which the second other side mass body is embedded.

40. The angular velocity sensor as set forth in claim 39, wherein the first flexible part is a beam having a surface formed by one axis direction and the other axis direction and having a thickness extended to a direction perpendicular to the surface, and the second flexible part is a hinge having a thickness in one axis direction and having a surface formed in the other axis direction.

41. The angular velocity sensor as set forth in claim 40, wherein one surface of the first flexible parts or the second flexible parts is selectively provided with a sensing unit sensing a displacement of the first mass body and the second mass body.

42. The angular velocity sensor as set forth in claim 37, wherein the third flexible part is a beam having a surface formed by one axis direction and the other axis direction and having a thickness extended to a direction perpendicular to the surface, and the fourth flexible part is a hinge having a thickness in one axis direction and having a surface formed in the other axis direction.

43. The angular velocity sensor as set forth in claim 42, wherein one surface of the third flexible part or the fourth flexible part is selectively provided with a driving unit driving the internal frame.
